(19) United States
(12) Patent Application Publication
(10) Pub. No.: US 2026/0200073 A1
(43) Pub. Date: Jul. 16, 2026

(54) PHYSICAL HUMAN-ROBOT INTERFACE FOR A PASSIVE LUMBAR EXOSKELETON

(71) Applicant: IUVO S.R.L, Pontedera (PI) (IT)

(72) Inventors: Matteo MOISE, Pontedera (PI) (IT); Giacomo GIUSFREDI, Pontedera (PI) (IT); Matteo BIANCHI, Pontedera (PI) (IT); Federica APRIGLIANO, Pontedera (PI) (IT); Giulio PROFACE, Pontedera (PI) (IT); Francesco GIOVACCHINI, Pontedera (PI) (IT)

(21) Appl. No.: 19/131,343

(22) PCT Filed: Dec. 14, 2023
(86) PCT No.: PCT/IB2023/062726

§ 371 Date: May 20, 2025

Related U.S. Application Data
(60) Provisional application No. 63/387,391, filed on Dec. 14, 2022.

(51) Int. Cl. B25J 9/00

(52) U.S. Cl. CPC B25J 9/0006

(57) ABSTRACT

A physical Human-Robot Interface (pHRI) is configured for a passive lumbar exoskeleton that aids an operator in exerting effort. The pHRI includes connections to the operator's body using a posterior corset, lumbar belt, posterior support belt, and thigh cuff. The pHRI features rigid kinematic structures with passive degrees of freedom (pDOFs) that prevent displacements in the human-machine interface that could lead to misalignments of the joint rotation axis. The pHRI incorporates two posterior struts that bypass the human multi-articular kinematic chain of the lower and middle back, connecting the pelvis to the torso bilaterally and transferring assistance from the exoskeleton to the body. Additionally, the pHRI has linkages between the posterior struts and the rigid corset to ensure effective transmission of assistance.

### CROSS-REFERENCE TO RELATED DISCLOSURES

This application incorporates by reference U.S. Provisional Application No. 63/218,708 filed Jul. 6, 2021, U.S. Provisional Application No. 63/421,860 filed Nov. 2, 2022, U.S. Provisional Application No. 63/421,862 filed Nov. 2, 2022, and U.S. Provisional Application No. 63/387,391 filed Dec. 14, 2022.

### FIELD OF THE DISCLOSURE

The disclosure relates to a physical Human-Robot interface (pHRI) for a passive lumbar exoskeleton adapted to augment an operator's performance, mitigate repetitive strain injuries, and/or assist in exerting forces.

### BACKGROUND

Workers in numerous settings are vulnerable to various occupational disease types, including overuse injuries, fatigue, and workplace accidents. A typical industrial disease includes overuse and strain resulting from biomechanical lumbar overload. Biomechanical lumbar overload can result from, for example, an operator lifting heavy-weighted items from the ground or from repeatedly lifting a moderate weight from the ground, mainly if the lifting is done with poor posture.

Biomechanical lumbar overload can also result from an operator bending or repeatedly stooping during work activities, such as a worker in an automobile manufacturing facility bending or stopping to work on the part of a vehicle that is low to or only accessible from the ground. Biomechanical lumbar overload may result in numerous and costly problems, including occupational diseases ranging from pain, muscle weakness, swelling, numbness, and restricted mobility of the back to debilitating pain and life-threatening accidents.

Low back pain is the primary cause of disability in individuals under the age of 50. It is most frequently associated with occupations requiring physical exertion resulting in acute injuries and cumulative stresses to the spinal anatomy. Other occupational diseases include degenerative cervical spine disease, discogenic low back pain, and spinal stenosis, to name a few, all of which can be exacerbated by poor posture and repetitive and/or arduous physical tasks. These occupational diseases can further lead to productivity loss and lawsuits in the workplace.

Wearable industrial exoskeleton technologies can improve endurance and safety in industrial settings, increase industrial productivity, and prevent common workplace injuries by minimizing overuse of muscles and tendons and preventing excessive stress on the spine and lower back. Exoskeletons can support and augment an operator during strenuous activities, including lifting, stooping, bending, squatting, and overhead work, to reduce employee fatigue and workplace injuries and improve precision and the speed of work tasks. Exoskeletons may be additionally valuable in repetitive and awkward activities. An exoskeleton allows operators to lift heavy objects safely and effortlessly with less effort, increasing productivity and accuracy by reducing muscle fatigue. Through an exoskeleton, older workers with valuable experience and intuition may be able to work longer than they otherwise could in physically demanding or challenging jobs.

An exoskeleton may be arranged to transfer loads through the exoskeleton to the ground in standing or kneeling positions, allowing operators to use heavy tools as if they were weightless. The exoskeleton can be configured to move naturally with the body and adapt to different body types and heights. The exoskeleton can replicate the body's biomechanical movement, while a corresponding physical human-robot interface (pHRI) can enwrap or engage with the operator's body.

An exemplary exoskeleton is arranged for the lower body, including the trunk and thighs, by enhancing performance, such as by reducing forces at the lower back (e.g., torque on the spine and lower back produced when lifting or squatting) and enabling the operator to perform repeated lifts over an extended period, with less effort. The exoskeleton may help the operator lift objects and reduce physical risks and discomfort from tasks carried out by bending at the knees, hips, or waist.

It has been found that the lower body, trunk, and upper body regions could benefit from active and passive exoskeletons. Muscle-activity reductions have been reported as an effect of active and passive exoskeletons. Exoskeletons can potentially reduce the underlying factors associated with work-related musculoskeletal injury.

However, while certain exoskeletons are available, several technical issues hinder the industry's practical and widespread use, adoption, and compliance. Existing passive exoskeletons exhibit pHRIs that are poorly adapted to the specific biomechanical requirements of different activities, such as bending vs. stooping. Other specific problems of existing pHRIs include discomfort for both passive and active exoskeletons, the device's weight, and poor alignment with human anatomy and kinematics.

Proper mechanical power transfer requires optimal tuning of the pHRI between the exoskeleton and anatomical joint rotation axes of users. Because the anthropometry of users can range widely, it can be challenging to maintain the stability of the exoskeleton while worn to avoid slippage and to enhance comfort. Further complicating matters is that the actuation unit of the exoskeleton must be able to efficiently transfer the assistance offered by the exoskeleton through the pHRI to the user's body while maintaining such comfort and avoiding injury to the user.

Due to different anthropometries, human exoskeleton kinematic compatibility requires a pHRI with appropriate kinematic structures that avoids misalignment between human joints and artificial joints. Likewise, it is desired to offer a pHRI that facilitates assistive action that mimics the physiological action at the lumbosacral area during flexion and extension of the trunk (e.g., while handling objects).

Given the preceding, therefore, there is a need for an improved pHRI that overcomes these problems in existing exoskeleton devices and incorporates kinematic structures with passive degrees of freedom (pDOFs) and that is capable of minimizing adverse effects while still transferring assistive forces using suitable structures.

### SUMMARY

Exoskeleton and pHRI embodiments of the disclosure are advantageously configured for relieving a load on one or more joints, such as the lumbosacral or hip joint, for preventing injury, and for assisting an operator's effort. Thus, the present disclosure's embodiments improve the prior art solutions discussed above, particularly from ergonomics, effectiveness, safety, and convenience of use. In addition, the exoskeleton embodiments advantageously allow an operator to receive assistive torque from the exoskeleton at the desired level of torque.

Existing pHRIs fail to address misalignment between the exoskeleton and the user. Thus, the disclosed pHRI provides a solution with improved points of connection to transfer assistive forces to the user through rigid structures of the pHRI. The disclosed mechanical kinematic chain facilitates the free movement of the user and allows the user to move the trunk freely. The kinematic chain is advantageously designed to fit compactly around the human body and to address kinematic compatibility between human and exoskeleton. The pHRI allows for simplified donning and doffing and offers improved personalization and customization for each user. The pHRI offers a light and robust structure and features a compact design while still enabling full mobility of the entire body and avoiding interference with surrounding objects.

According to an embodiment of the present disclosure, a lumbar exoskeleton is comprised of two laterally positioned independent actuation units containing a spring-loaded mechanism and a physical Human-Robot Interface (pHRI) that transfers force from the actuation units to the user. The pHRI comprises two rigid posterior struts (e.g., kinematic backbones) that bypass the human multi-articular kinematic chain (erector spinae) of the lower and middle back, connects the actuation unit to the torso, and transfers the assistive force from the exoskeleton to the body of a user.

The pHRI comprises one or more linkages with a kinematic chain to connect the posterior struts to a posterior corset structure worn by a user. The one or more linkages permit small horizontal and/or vertical translations and rotations of the trunk during lifting movements. The linkages enable trunk kinematic compatibility in the sagittal, transverse, and coronal planes. In an embodiment, the pHRI comprises a horizontal handle with free axial rotation between the two posterior struts to facilitate protraction-retraction movements of pelvis. The horizontal handle provides trunk kinematic compatibility in the transverse plane.

The pHRI comprises a kinematic structure with a rotational joint allowing for hip flexion-extension and provides hip kinematic compatibility in the sagittal plane. A free-to-rotate belt is provided for rear stabilization of the exoskeleton during lifting movements, and a hinge joint is provided to enable lateral bending hip kinematic compatibility in the coronal plane.

These and other features, aspects, and advantages of the present disclosure will help better understand the following description, appended claims, and accompanying drawings.

### BRIEF DESCRIPTION OF THE DRAWINGS

FIG. 1 is a diagram showing planes and axes of movement.

FIG. 2 is a rear or posterior perspective view of a passive lumbar exoskeleton comprising the pHRI.

FIG. 3 is a lateral view of a physical Human-Robot interface (pHRI) for a passive lumbar exoskeleton.

FIG. 4A is a perspective view of a linkage that connects a corset to a backbone of the pHRI.

FIG. 4B is a lateral view of the linkage of FIG. 4A providing translational movement.

FIG. 4C is a lateral view of the linkage of FIG. 4A providing rotational movement.

FIG. 4D is a rear or posterior view of the linkage of FIG. 4A providing rotational movement.

FIG. 5A is a perspective view of a variation of the linkage of FIG. 4A.

FIG. 5B is a lateral view of the linkage of FIG. 5A.

FIG. 5C is a top view of the linkage of FIG. 5A.

FIG. 6A is a perspective view of a variation of the linkage of FIG. 4A.

FIG. 6B is a lateral view of the linkage of FIG. 6A.

FIG. 7A is a schematic detail view showing the lumbosacral and hip level structures of the passive lumbar exoskeleton of FIG. 2.

FIG. 7B is a schematic detail view of a variation of the horizontal handle of FIG. 7A.

FIG. 8A is a rear or posterior view of a posterior frame of the corset.

FIG. 8B is a lateral view of the corset.

FIG. 8C is a schematic view of a frontal harness of the corset.

FIG. 8D is a schematic view of a variation of the frontal harness of the corset.

FIG. 9A is a schematic view of a belt system forming part of the pHRI

FIG. 9B is an exploded view of the belt system of FIG. 9A.

FIG. 10 is a schematic view of a variation of the belt system.

FIG. 11A is a schematic perspective view of another variation of the belt system.

FIG. 11B is a top perspective view of the belt system in FIG. 11A.

FIG. 12A is a perspective view of the thigh link assembly forming part of the pHRI.

FIG. 12B is a lateral view of a variation of the support panel forming part of the thigh link assembly.

FIGS. 12C-12F are schematic views of a variation of a thigh link assembly of FIG. 12A.

FIGS. 12G-12J are schematic views of another variation of the thigh link assembly of FIG. 12A.

FIG. 13 is a lateral view of various pelvis adjustment positions of the belt system and support panel.

FIG. 14A is a perspective view of a pHRI having lateral arms for hip breadth adjustment.

FIG. 14B is a rear or posterior view of the main regulation features of the pHRI of FIG. 14A at the trunk level.

The drawing figures are not necessarily drawn to scale. Instead, they are drawn to provide a better understanding of the components and are not intended to be limiting in scope but providing exemplary illustrations.

### DETAILED DESCRIPTION OF VARIOUS EMBODIMENTS

### A. Overview

A better understanding of different embodiments of the disclosure may be had from the following description read with the accompanying drawings in which reference characters refer to like elements. While the disclosure is susceptible to various modifications and alternative constructions, certain illustrative embodiments are in the drawings and are described below. It should be understood, however, that there is no intention to limit the disclosure to the embodiments disclosed; on the contrary, the intention covers all modifications, alternative constructions, combinations, and equivalents falling within the spirit and scope of the disclosure.

A better understanding of different embodiments of the disclosure may be had from the following description and accompanying drawings in which reference characters refer to like elements. In the following discussion, while the pHRI and exoskeleton are bilateral, one side (i.e., left or right corresponding to a user) may be referred to or represented for the sake of simplicity.

With respect to the use of plural and/or singular terms herein, those skilled in the art may translate the terms from the plural to the singular and/or from the singular to the plural as is appropriate to the context and/or application. The various singular/plural permutations may be expressly set forth herein for sake of clarity.

It will be understood that unless a term is defined to possess a described meaning, there is no intent to limit the meaning of such term, either expressly or indirectly, beyond its plain or ordinary meaning.

### B. Definitions

For ease of understanding, the disclosed embodiments of an exoskeleton and components for use therewith, the interior and exterior portions of the exoskeleton may be described independently. The Interior and exterior portions of the exoskeleton function together to support a user in exerting efforts.

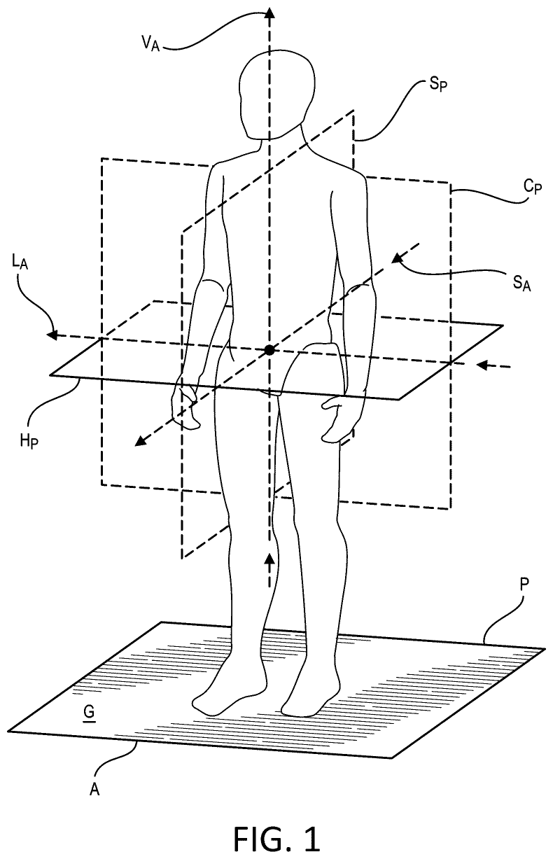

FIG. 1 exemplifies various planes and axes of movement used to identify the relative positions of body parts or relationships between those parts.

For further ease of understanding the embodiments of an orthopedic device as disclosed, a description of a few terms, when used, is necessary. As used, the term “proximal” has its ordinary meaning and refers to a location next to or near the point of attachment or origin or a central point located toward the center of the body. Likewise, the term “distal” has its ordinary meaning and refers to a location situated away from the point of attachment or origin or a central point or located away from the center of the body.

Medial is toward the body's midline or the median or sagittal plane (SP), which splits the body head-to-toe into two halves, the left and right. Lateral is the side or part of the body that is away from the middle. For example, for a leg, the medial side is on the inside of the exoskeleton, and the lateral side is on the outside of the device relative to the median plane.

The coronal or frontal plane (CP) divides the body into posterior (P) and anterior parts (A) and is perpendicular to the sagittal plane (SP). The term “posterior” also has its ordinary meaning and refers to a location behind or at another location's rear. The term “anterior” has its ordinary meaning and refers to a location ahead of or in front of another location.

The transverse or horizontal plane (HP) divides the body into superior and inferior parts and may be considered relative to the ground (G).

Therefore, the term “frontal plane” has its ordinary meaning and refers to a plane extending through a body to divide the body into the front or anterior and back or posterior halves. The term “sagittal plane” has its ordinary meaning and refers to a plane extending through a body to divide the body into left and right halves, as in the mid-sagittal plane referenced above. The term “transverse plane” has its ordinary meaning and refers to a plane extending through a body to divide the body into the top or upper and bottom or lower halves.

Movement at the joints takes place in a plane about an axis, and there are three axes of rotation, including the sagittal axis (SA), the lateral axis (LA), and the vertical axis (VA). The sagittal axis passes horizontally from posterior to anterior and is formed by the intersection of the sagittal and transverse planes. The lateral axis passes horizontally from left to right and is formed by the intersection of the frontal and transverse planes. The vertical axis passes vertically from inferior to superior and is formed by the intersection of the sagittal and frontal planes.

Flexion and extension are movements that occur in the sagittal plane. They refer to increasing and decreasing the angle between two body parts: flexion refers to a movement that decreases the angle between two body parts. Extension refers to a movement that increases the angle between two body parts. Abduction is a movement away from the midline-just as abducting someone is to take them away. Adduction is a movement toward the midline.

As used, the terms “rigid,” “flexible,” “compliant,” and “resilient” may distinguish characteristics of portions of certain features of the actuation system. The term “rigid” should denote that an element of the actuation system, such as a frame, is generally devoid of flexibility. Within the context of features that are “rigid,” it should indicate that they do not lose their overall shape when force is applied and may break if bent with sufficient force. The term “flexible” should denote that features are capable of repeated bending such that the features may be bent into non-retained shapes, or the features do not retain a general shape, but continuously deform when force is applied. The term “resilient” may qualify such flexible features as generally returning to an initial general shape without permanent deformation. As for the term “semi-rigid,” this term may connote properties of support members or shells that provide support and are free-standing; however, such support members or shells may have flexibility or resiliency.

The term “actuation unit” refers to a passive device that does not draw energy from an external power supply. As described herein for exemplary purposes, the actuation mechanism is described as an elastic or spring-like member.

The term “approximately” means a value within a statistically significant range of value or values, such as the stated length, distance, weight, height, angle, or force.

The term “corset” refers to an upper-body brace that secures the upper back, shoulder, and chest regions of a user.

The term “exoskeleton” refers to an assistive device that can be worn or otherwise attached to a user and contributes to realizing a support, hold, or force transmission function with respect to one or more portions of the user.

The term “kinematic backbone” refers to a rigid kinematic strut that bilaterally connects the pelvis to the upper trunk.

Unless otherwise stated, the term “kinematic chain” generally refers to an assembly of rigid components connected by joints or linkages to provide constrained motion that follows a mathematical model for a mechanical system. As the word chain suggests, the rigid bodies, or linkages, are constrained by their connections to other bodies, or linkages. In reference to the linkage, the kinematic chain refers to a strap, wire, rod, chain, band, or similarly functional device for tethering the corset 102 and strut 110 together.

The term “linkage” refers to a connection device, e.g., coupling, which unites components together.

The term “Physical Human Robot Interface” or “pHRI” refers to a device that connects an exoskeleton, or robot, to the human body.

The term “protraction” is defined as rotation away from the reference limb. The term “retraction” is defined as rotation toward the reference limb.

The terms “substantial” or “substantially” mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. The terms “substantial” or “substantially” mean±10% in some embodiments, ±5% in some embodiments, and ±1% in some embodiments.

The term “user” refers to a person who uses the exoskeleton. The user may be a patient or an operator.

C. Various Embodiments of the Physical Human-Robot Interface (pHRI)

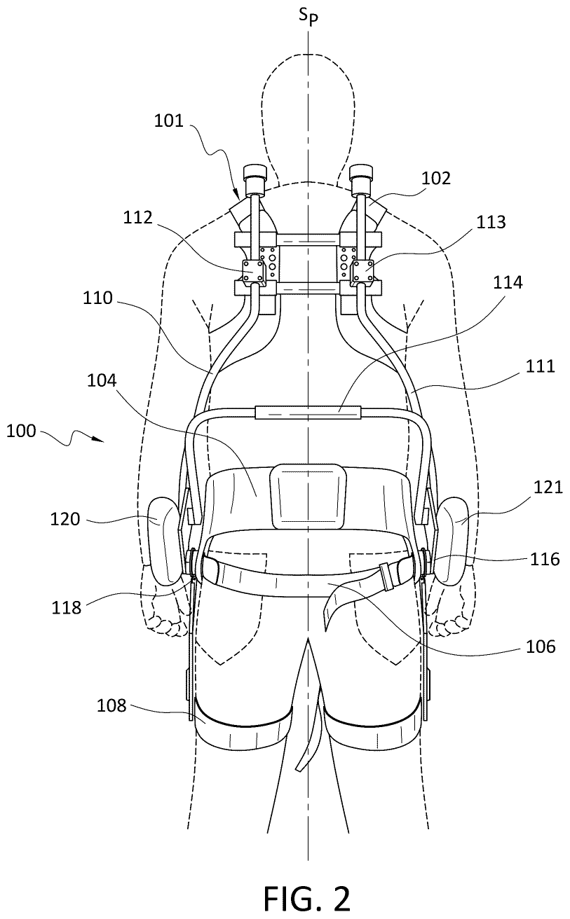

Referring to the embodiment in FIGS. 2, a physical Human-Robot interface (pHRI) 101 is configured to be worn by user and to ensure safe and effective force transfer between the user and exoskeleton 100. The pHRI 101 comprises an upper-body brace corset 102, lumbar belt system 104, posterior support belt 106, and thigh link assembly 108 as connection points to the user. The pHRI 101 is generally symmetrical with respect to a sagittal plane of the user.

The pHRI 101 comprises posterior struts 110, 111 that bilaterally connect the pelvis of a user to the upper trunk. The posterior struts 110, 111 extend in a posterior to anterior direction approximately from a medial-superior region of the trunk to lateral regions of the hips. The posterior struts 110, 111 bypasses the human multi-articular kinematic chain (erector spinae) of the lower and middle back of a user and accordingly reduces the biomechanical load imposed on the lumbosacral joint of a user. The posterior struts 110, 111 are rigid, rod-like structures that are curvilinear or contorted and deviate from mimicking the alignment of the spine of a user. The rigid posterior struts 110, 111 are more advantageous than flexible beams that are parallel to the spine of a user because the posterior struts 110, 111 improve the transfer of assistive forces and reduce issues of misalignment.

The pHRI 101 comprises one or more linkages 112, 113 to connect the posterior struts 110, 111 to the corset 102. The linkages 112, 113 permit the corset 102 to follow movements of the trunk while the posterior struts 110, 111 remain connected to the pelvic region of a user. Additionally, the weight of the exoskeleton 100 is concentrated at the iliac crests while the trunk is free to move without bearing the load of the exoskeleton 100. Because of the fixed length of the linkage 112, the connection between the posterior strut 110 and the corset 102 is guaranteed during flexion and extension movement of the trunk.

The linkages 112, 113 allow for small horizontal and/or vertical translations and rotations of the trunk during lifting movements. The linkages 112, 113 support kinematic compatibility in the sagittal, transverse, and coronal planes to restrict movement and guarantee the transmission of assistive force.

The embodiment of the pHRI 101 in FIG. 2 comprises a horizontal handle 114 with free axial rotation to achieve differential transmission between the posterior struts 110, 111. The horizontal handle 114 is represented as a telescopic, free-to-rotate, posterior lumbar area joint preferably connecting the posterior struts 110, 111; however, the horizontal handle 114 may be rigidly connected to opposing actuation units 120, 121 of the exoskeleton 100. The horizontal handle 114 enables protraction and retraction movements of the trunk. The horizontal handle 114 supports trunk kinematic compatibility in the transverse plane to decrease the energy cost to the user, e.g., while walking.

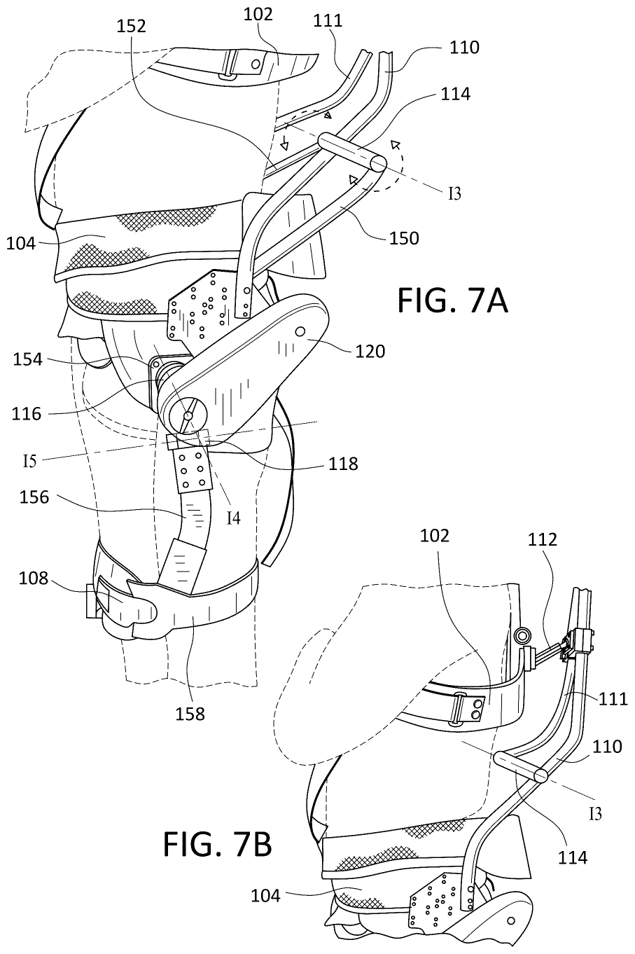

The pHRI 101 comprises a kinematic hip rotational joint 116 allowing for hip flexion and extension. The hip rotational joint 116 enables kinematic compatibility in the sagittal plane. The hip rotational joint 116 guarantees freedom of pelvis movement while bending and during posterior or anterior pelvic tilts. The pHRI 101 further comprises a lateral hinge joint 118 for lateral bending of the hip. The lateral hinge joint 118 enables kinematic compatibility in the coronal plane. The hip rotational joint 116 and lateral hinge joint 118 are described in greater detail below with reference to FIG. 7.

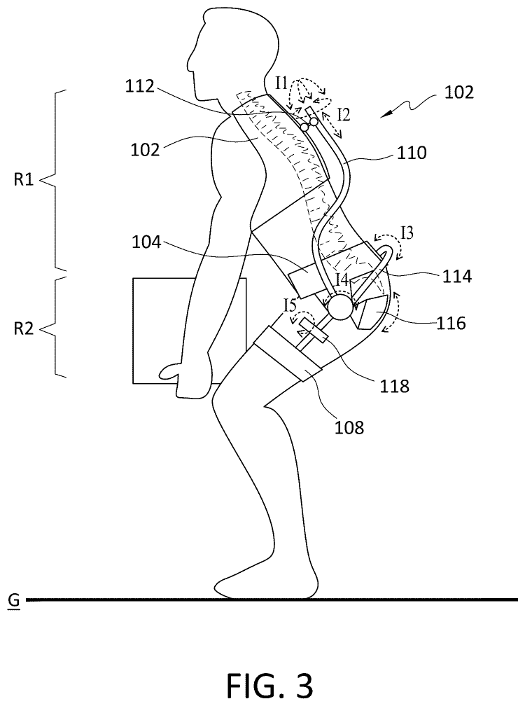

Referring to the embodiment in FIG. 3, the pHRI 101 offers kinematic compatibility at both the trunk region R1 and the hip region R2 by providing kinematic structures with passive degrees of freedom (pDOFs). The linkage 112 between the corset 102 and the posterior strut 110 permits small horizontal and/or vertical translations and rotations of the trunk. The translations and rotations are constrained by a rotating corset joint axis I1, having an attachment point to the corset 102, and a backbone axis I2, being defined in the direction parallel to the posterior strut 110. The horizontal handle 114 enables trunk protraction and retraction movements about a handle axis I3. The hip rotational joint 116 permits flexion and extension about a first hip axis I4 while the lateral hinge joint 118 enables lateral bending at a second hip axis I5.

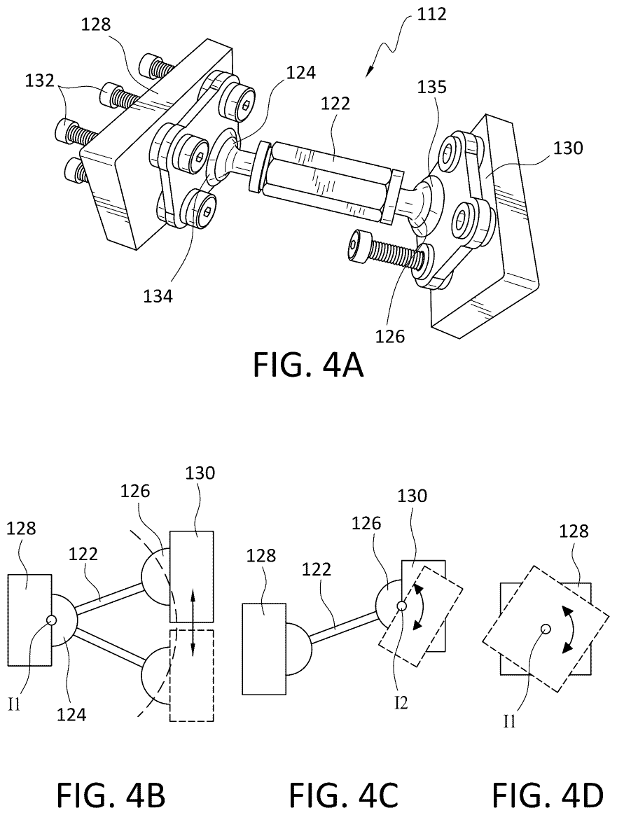

FIGS. 4A-4D depict an embodiment of the linkage 112 for the pHRI 101. The linkage 112 comprises a rigid kinematic chain 122 to constrain movement between the corset 102 and the posterior strut 110 thereby guaranteeing the transmission of assistance. Thus, the length and material properties of the kinematic chain 122 determine the constraint of the linkage 112 between the corset joint axis I1 and the backbone axis I2. The kinematic chain 122 is connected to a first spherical joint 124 at a first connector 128 and a second spherical joint 126 at a second connector 130. The kinematic chain 122 preferably defines a fixed length between the first connector 128 and the second connector 130. The spherical joints 124, 126 allow for both small translations and rotations between the corset 102 and strut 110. The spherical joints 124, 126 may be confined to housing 134, 135 that are connected to the first and second connectors 128, 130, respectively. In an embodiment, the first connector 128 attaches to the corset by fasteners 132 and the second connector 130 attaches to the backbone by fasteners 132. Exemplary fasteners include screws, pins, bolts, rivets, and the like. In an embodiment, the kinematic chain 122 is adjustable and may be fixed to different lengths. In an embodiment, the kinematic chain 122 is a strap, wire, rod, chain, band, or similarly functional device for establishing a connection between the corset 102 and strut 110.

FIG. 4B depicts translation of the second connector 130 and rotation of the second spherical joint 126 about the attachment point of the rotating corset joint axis I1 defined by the first spherical joint 124. FIG. 4C depicts rotation of the second connector 130 about the backbone axis I2 defined by the second spherical joint. FIG. 4D depicts rotation of the second attachment about the attachment point of the corset joint axis I1 defined by the first spherical joint 124.

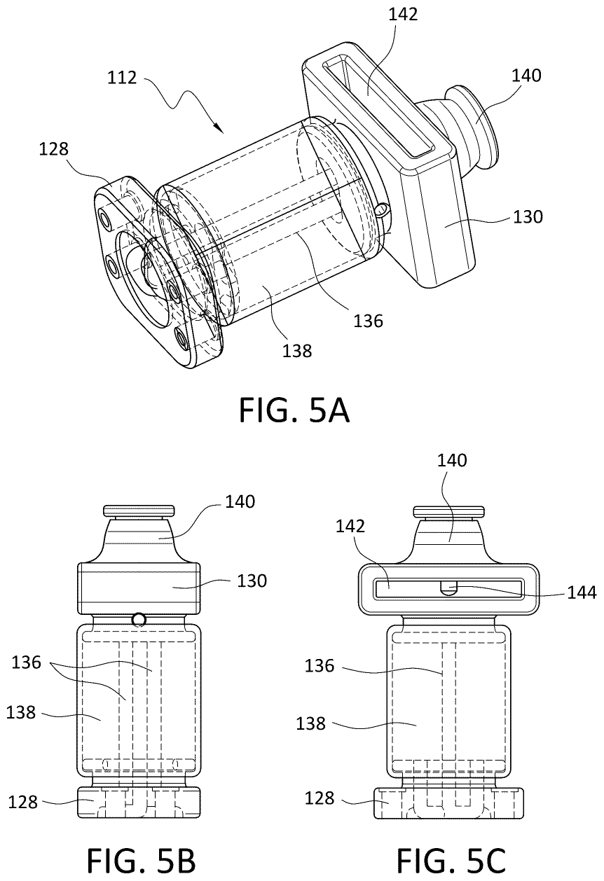

FIGS. 5A-5C depict a variation of the linkage 112 for the pHRI 101. In an embodiment, the first connector 128 is fixed to the corset 102, and the second connector 130 adjustably attached or fixed to the first posterior strut 110. The linkage 112 features a cable or wire 136 that connects the first connector 128 to the second connector 130. The wire 136 permits small translational and rotational movement between the corset 102 and strut 110. The linkage 112 may comprise a flexible cover 138 to house and protect the wire 136 while not interfering with the pDOFs. In an embodiment, the second connector 130 of the linkage 112 comprises a channel 142 to receive the posterior strut 110 and an adjustable control 140 to permit regulation of connection along the posterior strut 110 by means of a spring pin 144 to accommodate users of varying heights and different anthropometries. The spring pin 144 of the adjustable control 140 is configured to interface with a plurality of apertures (e.g., apertures 241) defined along the posterior strut 110.

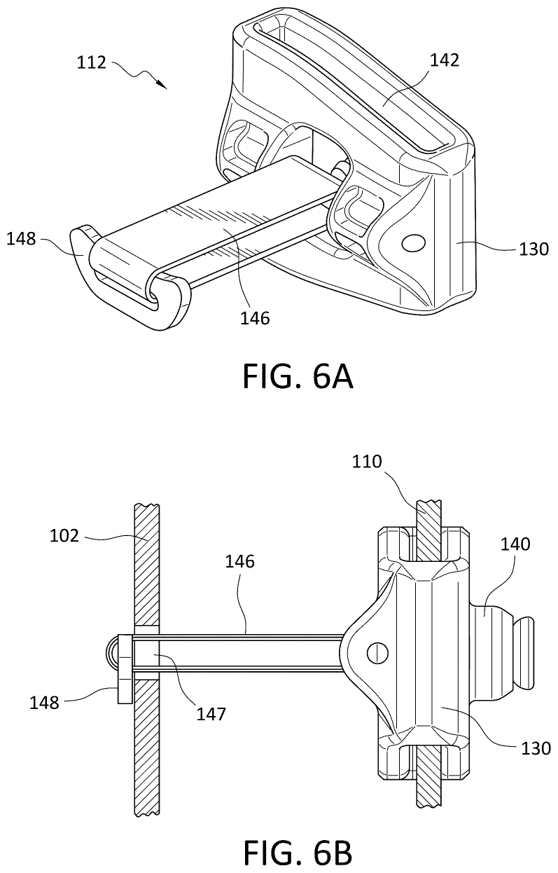

FIGS. 6A-6B depicts another variation of the linkage 112 for the pHRI 101. The linkage 112 features a strap 146 that connects a connector 148 to the second connector 130. The strap 146 functions similarly to the kinematic chain 122 and wire 136 by permitting small translational and rotational movement between the corset 102 and strut 110. The connector 148 may interface with one or more slots 147 formed on the corset 102 to permit regulation of the connection between the posterior strut 110 and the corset 102. In an alternative embodiment, both the corset 102 and posterior strut 110 comprise slots 147 to receive one or more connectors 148 to enable controlled adjustment of the connection between the corset 102 and the posterior strut 110. One skilled in the art will recognize that features of the different embodiments in FIGS. 4-6 may be combined to provide a linkage 112 with various connective features between the corset 102 and posterior strut 110.

FIGS. 7A-7B depict the lumbosacral and hip level structures of the pHRI 101. The pHRI 101 comprises a horizontal handle 114 having free axial rotation about the handle axis I3. The horizontal handle 114 is represented as a telescopic, free-to-rotate, posterior lumbar area joint preferably connecting the posterior struts 110, 111. In an embodiment, the horizontal handle 114 is formed between a first posterior strut 150 and a second posterior strut 152. The horizontal handle 114 presents a central connection as a cylindrical joint that allows the free rotation of lower right and left extremities with respect to one another.

The horizontal handle 114 is preferably arranged proximate to an inferior end of the posterior struts 110, 111 to improve comfort and permit freedom or rotation. Arranging the horizontal handle 114 proximate to a superior end of the posterior struts 110, 111 is not desirable due to the length of the posterior struts 110, 111. Such an arrangement would force a greater projected distance between the actuation units 120, 121 and thereby create discomfort or prevent the rotation of the horizontal handle 114.

Assistive torque provided at the hip level varies with the relative angle between the trunk and the legs of a user. The pHRI 101 is provided with a hip rotational joint 116 between a support panel 154 of a thigh link assembly 108 and the actuation unit 120 to guarantee freedom of pelvis movement while bending (e.g., posterior or anterior pelvic tilts). The pHRI 101 also comprises a thigh link assembly 108 having a rigid thigh support 156 and being connected to the lumbar belt system 104 and actuation unit 120, the thigh link assembly 108 being rotatable about the first hip axis I4 and defining or cooperating with a thigh strap 158 engageable by a thigh of the operator to produce resistive moments about the first hip axis I4. The thigh link assembly 108 also comprises a lateral hinge joint 118 to permit lateral bending or abduction-adduction movement about the second hip axis I5.

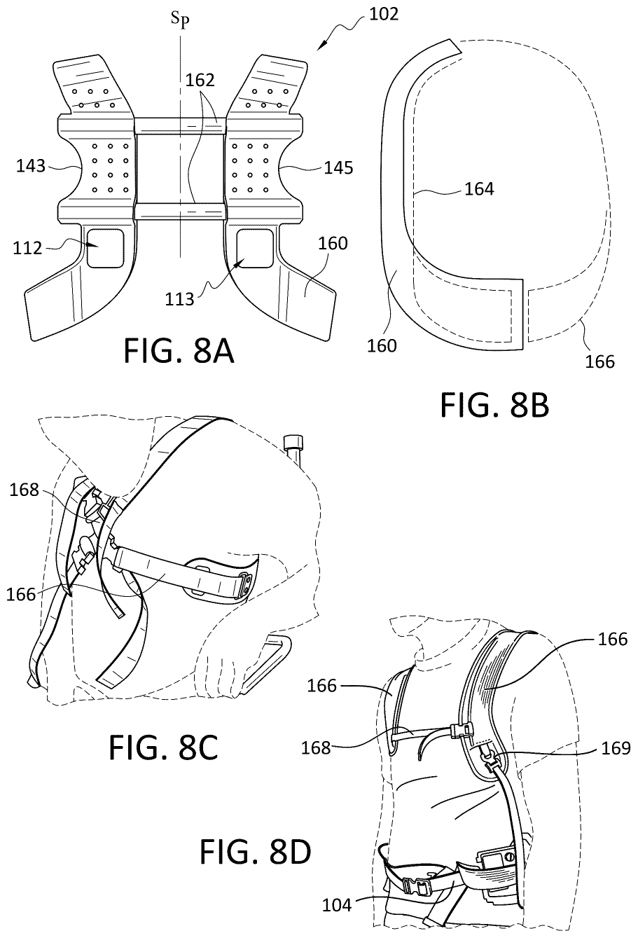

FIGS. 8A-8D depict various features of the corset 102 for the pHRI 101. The corset 102 comprises a torso vest or frontal harness 166 that is fixed to the upper part of the body of a user (i.e., the torso itself) and a rigid posterior frame 160 that is connected to the posterior struts 110, 111 by the linkages 112, 113. In an embodiment, the posterior frame 160 comprises first and second backplates 143, 145 that correspond to the first and second posterior struts 110, 111 and individual linkages 112, 113. Having distinct first and second backplates 143, 145 allows the corset 102 to accommodate width adjustment features (e.g., telescopic rods 162). The linkages 112, 113 connect to the posterior frame 160 below one or more horizontal telescopic rods 162. The telescopic rods 162 permit self-regulation of chest breadth of a user. The connection of the linkages 112, 113, below the telescopic rods 162 permits freedom of movement and does not interfere with the upper torso, neck, and scapular joints. This avoids constrained movements during the first movements of crouching and reaching. The connection of the linkages 112, 113 also improves encumbrance and weight by reducing the length needed for the posterior struts 110, 111.

The posterior frame 160 comprises a soft pad 164 to interface between the posterior frame 160 and the user to increase comfort. The frontal harness 166 is constructed as a jacket or vest. FIG. 8C depicts an embodiment of the frontal harness comprising a chest strap 168. The chest strap 168 may include buckles or other fastening means having adjustable length regulation. FIG. 8D depicts another variation of the frontal harness 166. The frontal harness 166 may comprise a chest strap 168 and connecting strap 169 to attach the lumbar belt system 104 to the frontal harness 166 for increased stability. The chest strap 168 of the frontal harness 166 assists in regulating the telescopic rods 162 to an appropriate length for the user.

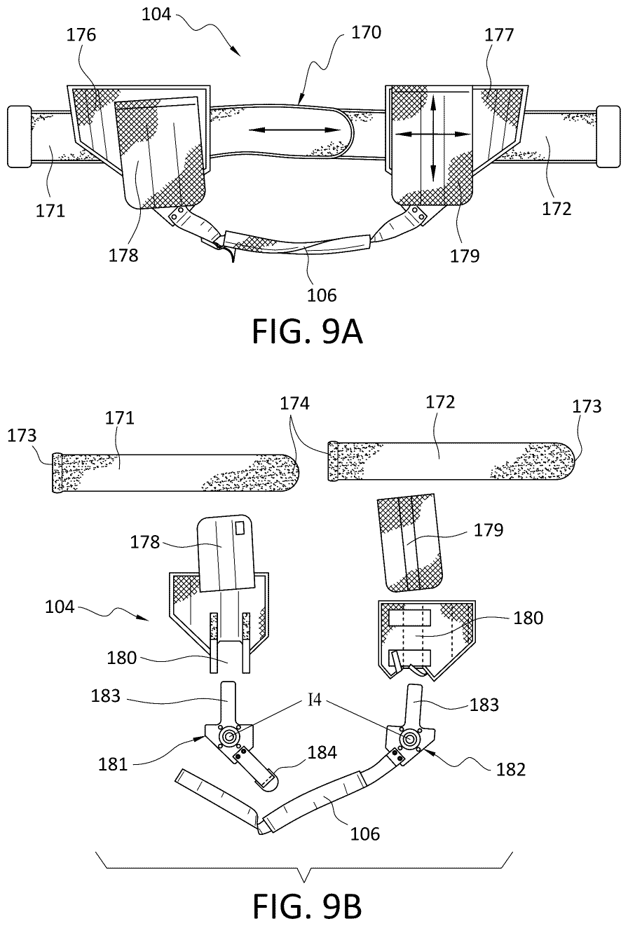

FIGS. 9A-9B depict features of the lumbar belt system 104 for the pHRI 101. The lumbar belt system 104 enables the pHRI 101 to position the exoskeleton 100 on the iliac crest to load the legs of a user instead of the trunk. The lumbar belt system 104 also algins the actuation unit 120 and hip rotational joint 116 to be coaxial at the first hip axis I4. The lumbar belt system 104 comprises a dual waist belt assembly 170 to enables circumferential regulation, the dual waist belt assembly having a first semi-belt 171 and a second semi-belt 172. The first and second semi-belts 171, 172 each have anterior connecting ends 173 and posterior connecting ends 174. The lumbar belt system 104 comprises removeable hip pads 176, 177 to connect the dual waist belt assembly 170 of the lumbar belt system 104 to rotational joint assemblies 181, 182 of the actuation units 120, 121. The rotational joint assemblies facilitate rotation about the first hip axis I4. The hip pads 176, 177 may comprise receiving segments 180 to receive rigid supports 183 of the rotational joint assemblies 181, 182. The lumbar belt system 104 also comprises hip cushions 178, 179 to provide comfort to the user at the hip level.

The pHRI 101 also comprises a posterior support belt 106. The posterior support belt 106 comprises a fastener 184 to accommodate different anthropometries of users. The posterior support belt 106 is constructed as a free-to-rotate belt and may comprise a pad for cushioning the rear end of a user. The posterior support belt 106 counteracts the motion trend of the pHRI 101 with respect to the body of a user and provides increased stabilization.

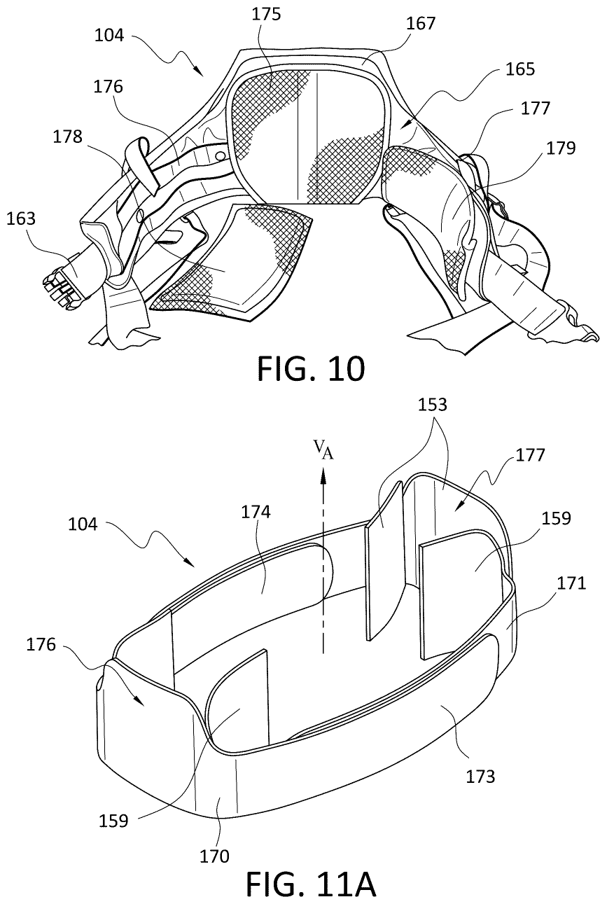

FIG. 10 depicts an alternative embodiment of the lumbar belt system 104. In an embodiment, the lumbar belt system 104 comprises a single waist belt assembly 165. The single waist belt assembly 167 comprises hip pads 176, 177, a lumbar cushion 175, and hip cushions 178, 179. The single waist belt assembly 167 includes a buckle 163 or other fastening means having adjustable length regulation.

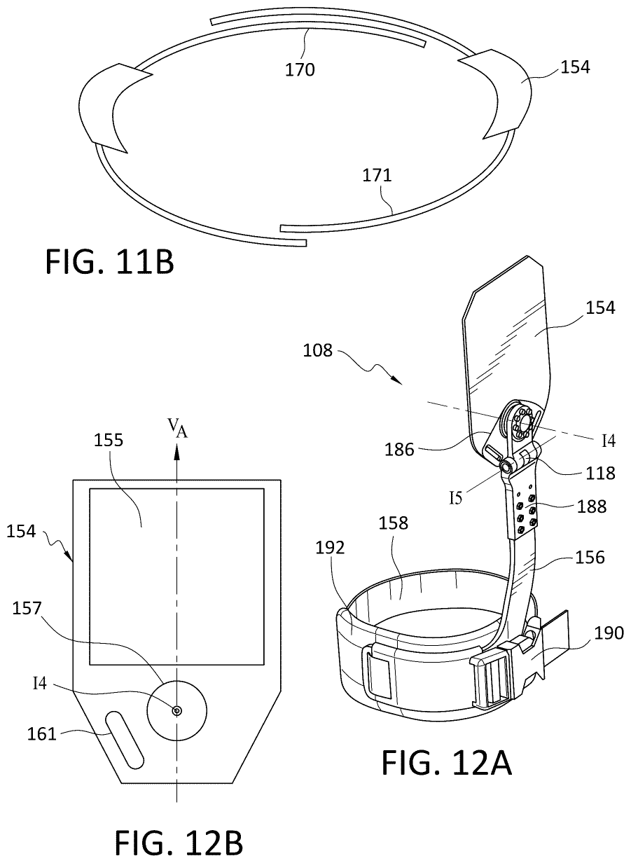

FIGS. 11A-11B depict another variation of the lumbar belt system 104 that may be assembled on one or more support panels 154 of a thigh link assembly 108. In an embodiment, the lumbar belt system 104 comprises first semi-belt 171 and a second semi-belt 171, wherein the first and second semi-belts respectively comprise hip pads 176, 177 featuring loop surface material 153 and flaps 159 to interface with support panels 154 of the thigh link assembly 108. Referring the FIG. 11B, it is possible to change the position of the lateral support panels 154 of the thigh link assembly 108 and align them with the human joints by acting independently on the posterior and anterior regulations of the belt system 104 length.

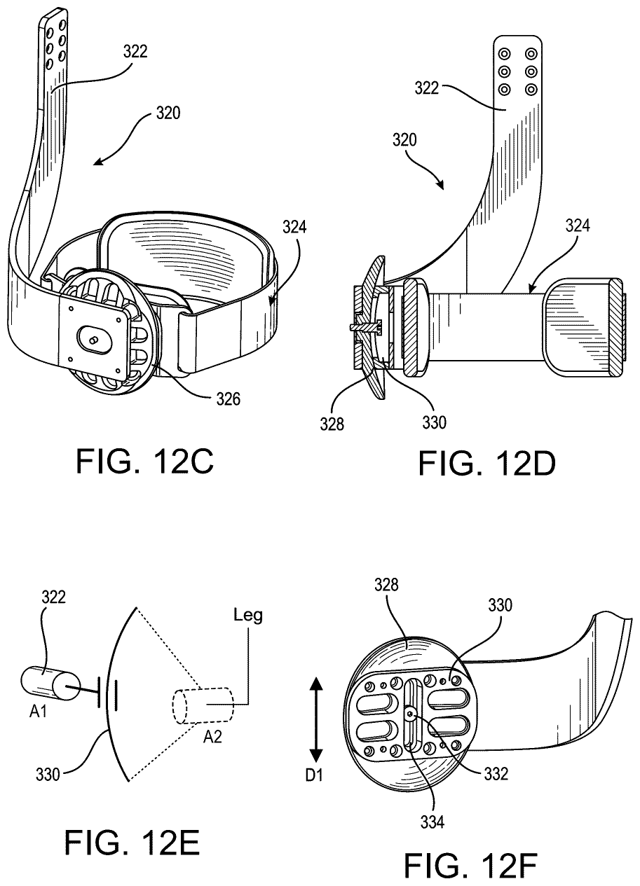

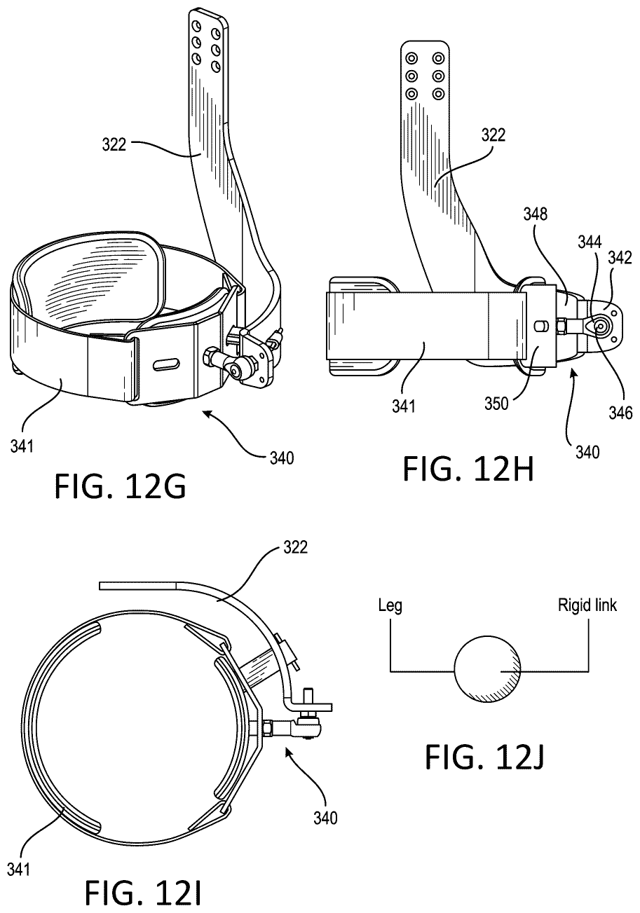

FIGS. 12A-12B depict features of the thigh link assembly 108 for the pHRI 101. The thigh link assembly 108 comprises a support panel 154 having a rotational notch 186. The rotational notch 186 restricts rotational movement about the first hip axis I4. The thigh link assembly 108 has a rigid member 188 that may rotate about the first hip axis I4, the rigid member 188 also comprising the lateral hinge joint 118 that may rotate about the second hip axis I5. The rigid member 188 connects to the thigh support 156. The thigh strap 158 features a soft pad 192 to cushion the thigh of a user. The thigh strap 158 also includes a buckle 190 or other fastening means having adjustable length regulation.

FIG. 12B depicts a support panel 154 of the thigh link assembly 108 having hook surface material 155 to interface with the loop surface material 153 of the lumbar belt system 104 depicted in FIG. 11. The support panel 154 comprises a bushing or bearing 157 for pivot connection about the first hip axis I4. The support panel may also comprise a slot 161 to receive the posterior support belt 106.

FIGS. 12C-12F exemplify a variation of the thigh link assembly 108 as thigh link assembly 320. The self-adaptability of the thigh link assembly 320 compensates for possible misalignments between the exoskeleton and human hip joints that could cause, in case of a non-adaptable thigh cuff, an uncomfortable interaction between the user and the exoskeleton and mismatching between the thigh and cuff surfaces.

The thigh cuff 324 involves the implementation of a passive Degree of Freedom of a coupling 326 at the level of thigh cuff to improve the self-adaptability of the thigh link assembly 320 with the user's thigh both during the donning procedure and along the leg range of motion while walking or performing other movements involving hip flexion extension. The self-adaptability of the thigh cuff 324 compensates for possible misalignments between the robotic and human hip joints that could cause, in case of a non-adaptable thigh cuff, non-perfect matching between the thigh and cuff surfaces, with consequent non comfortable interaction between the user and the robot.

As depicted, a thigh support 322 connects to the thigh cuff 324, e.g., including a strap, adapted to extend about the thigh of the user. The thigh cuff 324 includes the coupling 326 having first and second components 328, 330. The thigh cuff 324 is connected to the thigh support 322 by the first component 328 and the second component 330 of the coupling 326. The first component 328 comprises a concave, spherical pin surface 332. The second component 330 rotates on the spherical pin surface 332 of the first component 328. The second component 330 is forced, by a slot 334 formed by the second component 330, to travel in direction D1 against the spherical pin surface 332. By being configured and dimensioned to follow a single direction D1, the rotation of the thigh cuff 324 is limited to prevent misalignment and improve comfort.

Referring to FIGS. 12E and 12F, the thigh cuff 324, as provided by the first and second components 328, 330, permit the rotation of the thigh cuff 324 along an axis A1 perpendicular to the user's hip flexion-extension to obtain a free adjustment of the force application point regarding a user's thigh width. The thigh cuff 324 is also arranged to rotate about a remote axis A2 parallel to the user's hip flexion-extension to guarantee the comfort in case of misalignment.

FIGS. 12G-12J illustrate another variation of the thigh link assembly 108 as thigh link assembly 340. A spherical joint 342 connects the thigh cuff 341, e.g., including a strap, to the thigh support 322. The spherical joint includes a mount 344 having a ball 346 to facilitate self-adaptability of the thigh cuff 324 in compensating for possible misalignments between the exoskeleton and user hip joints. The ball 346 is connected via rod 348 to a bracket 350 of the thigh cuff 341. The disclosed thigh link assemblies 108, 320, 340 offer an improved connection between the exoskeleton and user and offer a more fluid passive Degree of Freedom offered by the pHRI 101.

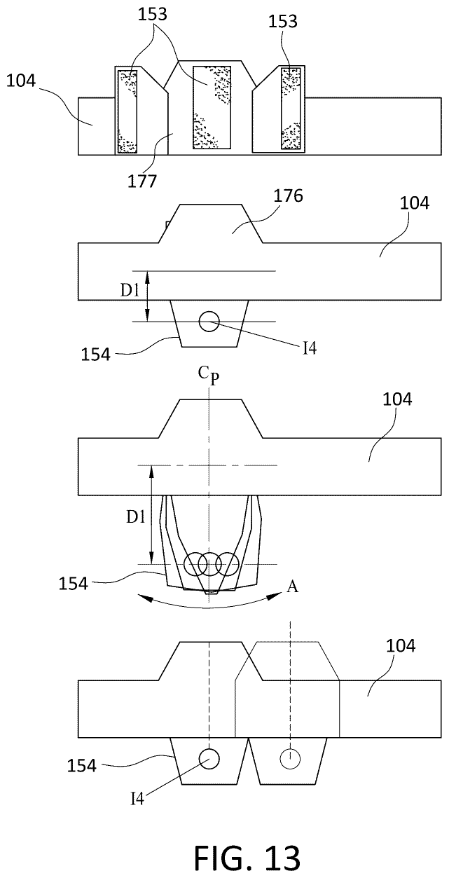

FIG. 13 depicts application of the lumbar belt system 104 with the support panel 154 of the thigh link assembly 108. The relative position between the lumbar belt system 104 and the rotational pDOF about the first hip axis I4 can be adjusted in different directions. The lumbar belt system 104 may be adjusted to choose the most comfortable position of the lumbar belt system without losing the alignment between the hip and the rotational axis of the actuation unit 120 or first hip axis I4. This is achieved by adjusting the distance D1 to various longitudinal positions where the loop surface material 153 of the lumbar belt system 104 interfaces with the hook surface material 155 of the support panel 154. The lumbar belt system 104 can be adjusted to tilt the rotational pDOF to ensure that pHRI 101 alignment with different pelvis anthropometries. This is achieved by adjusting the longitudinal distance D2 and angle A to the desired tilt. This accommodates users with neutral or zero tilt, anterior tilt, or posterior tilt of the pelvis and ensures that hip pads 176, 177 and hip cushions 178, 179 is adjacent to or touching the iliac crest and the first hip joint I4 is always aligned. Additionally, by acting independently on the posterior and anterior regions of the lumbar belt system 104 length L, it is possible to change the position of the lateral support panels 154 and align them with human joints.

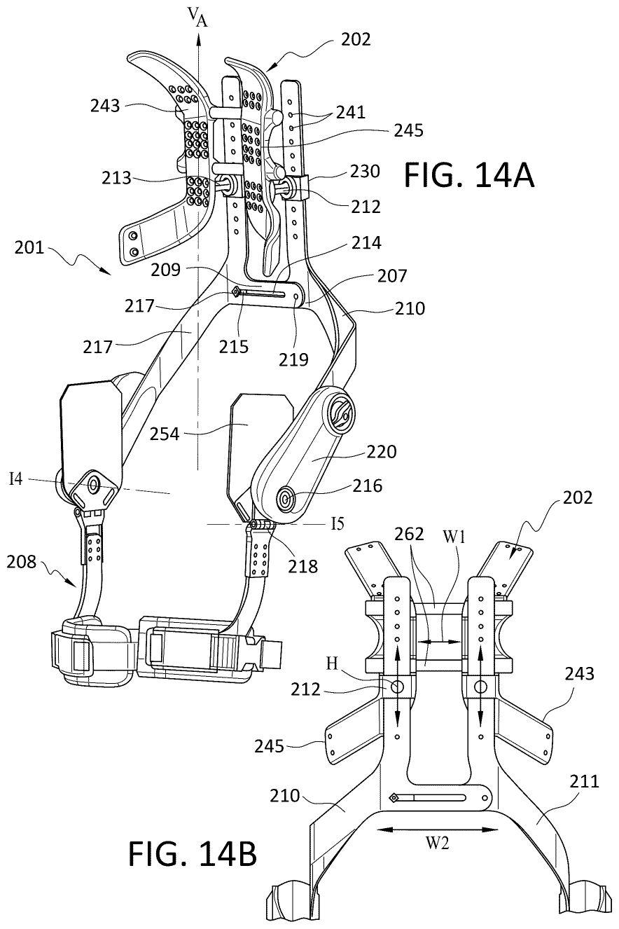

FIG. 14A depicts an alternative embodiment of the pHRI 101 for the exoskeleton 100. The pHRI 201 comprises a corset 202, posterior struts 210, 211, linkages 212, 213, and thigh link assemblies 208. The pHRI 201 is provided with a hip rotational joint 216 between a support panel 254 of a thigh link assembly 208 and an actuation unit 220 to guarantee freedom of pelvis movement while bending (e.g., posterior or anterior pelvic tilts).

In an embodiment, the corset 202 comprises first and second backplates 243, 245 that correspond to the first and second posterior struts 210, 211 and individual linkages 212, 213, respectively. Having distinct first and second backplates 243, 245 allows the corset 202 to accommodate width adjustment features (e.g., lateral arms).

The posterior struts 210, 211 comprise lateral arms 207, 209 that interface with each other to regulate the width W2 of the pHRI 201. In an embodiment, each posterior strut comprises at least one lateral arm. The lateral arms 207, 209 of the posterior struts 210, 211 includes elongate channels 214, 215 that interact with one or more guides 217, 219 to enables movement parallel to the lateral axis. The term “elongate channel” generally refers to a narrow slot. When the pHRI 201 is configured without a horizontal handle, providing a linkage 212 like those described in FIGS. 5-6 guarantees the alignment by a wire-based coupling at the thoracic level and avoids the pDOF of the horizontal handle without losing effectiveness in aligning the pHRI 201 on the transverse plane.

The posterior strut 210 comprises apertures 241 to receive an attachment 230 of the linkage 212. The attachment 230 may be adjusted along the posterior strut 210 to accommodate users of varying heights. The pHRI 201 features thigh link assemblies similar to those described above comprising a support panel 254 and a lateral hinge joint 218 that are rotatable about first and second hip axes I4, I5. FIG. 14B depicts the various positional adjustments that can be made for the corset 202 of the pHRI 201. The width W1 of the corset 202 is adjusted by the telescopic rods 262, and the height H of the corset 202 with respect to the posterior struts 210, 211 is adjusted by features of linkage 212, which are similar to those described above in FIGS. 4-6. In an alternative embodiment, the corset 202 comprises lateral arms, instead of telescopic rods 262, to accommodate width adjustment in a similar manner to the lateral arms 207, 209 of the posterior struts 210, 211. In a preferred embodiment, the first posterior strut 210 is substantially similar and symmetrical with the second posterior strut 211 with the sagittal plane of a user.

The features and/or components of one embodiment, example, or figure discussed, shown, or suggested hereinabove may be combined with features and/or components of other embodiments, examples, or figures discussed, shown, or suggested herein to provide embodiments, examples, or implementation variations that are not explicitly verbally or visually described or shown herein. The embodiment depicted in FIGS. 14A-14B does not feature a horizontal handle

Despite depicting a pHRI for a passive lumbar exoskeleton, it will be appreciated that the embodiments may be utilized in a powered exoskeleton. For example, an exoskeleton according to the depicted embodiments may comprise a power source, one or more actuators, and/or a controller configured to provide an assistive torque to an operator corresponding to the angle between the thigh and the trunk, with a transparent range of motion in which no assistive torque is provided, and/or with different levels of actuation as described herein. Accordingly, the embodiments are not limited to a passive exoskeleton, but rather extend equally to a powered exoskeleton.

It is to be understood that even though numerous characteristics and advantages of various embodiments of the present disclosure have been outlined in the foregoing description, together with details of the structure and function of various embodiments thereof, this detailed description is illustrative only, and changes may be made in detail, especially in matters of structure and arrangements of parts within the principles of the present disclosure to the full extent indicated by the broad general meaning of the terms in which the appended claims are expressed.

1.-20. (canceled)

21. A physical Human-Robot Interface (pHRI) arranged for attaching a lumbar exoskeleton to a user, the pHRI comprising:
a corset arranged for attaching the pHRI to a trunk of the user;
first and second posterior struts connected to the corset and arranged to bypass loads imposed on erector spinae of lower and middle back of the user and transfer assistive force from first and second actuation units of the lumbar exoskeleton to the user;
wherein the first strut is connected to the corset by an adjustable linkage, the adjustable linkage including a first connector fixed to the corset and further including a second connector fixed to the first posterior strut; and
wherein movement between the first strut and corset is constrained by a kinematic chain of the adjustable linkage to horizontal and vertical translations, and rotation of the trunk of the user in sagittal, transverse, and coronal planes, the kinematic chain having a fixed length between the first connector and the second connector.

22. The pHRI of claim 21, wherein the pHRI is substantially symmetrical with respect to a sagittal plane of the user.

23. The pHRI of claim 21, wherein the second connector comprises an adjustable control to engage with a plurality of apertures along the first posterior strut.

24. The pHRI of claim 21, wherein the second connector comprises an adjustable control arranged to regulate height along the first posterior strut by means of a spring pin.

25. The pHRI of claim 21, wherein the corset comprises a rigid posterior frame and a frontal harness.

26. The pHRI of claim 25, wherein the rigid posterior frame of the corset defines a first backplate and a second backplate connected by one or more telescopic horizontal rods to regulate width between the first backplate in a horizontal direction.

27. The pHRI of claim 21, wherein the first posterior strut includes at least one lateral arm to regulate width of the pHRI in a horizontal direction parallel to a first hip axis.

28. The pHRI of claim 21 further comprising a first kinematic hip rotational joint connecting the first posterior strut to the first actuation unit configured to assist hip flexion and extension movements about a first hip axis.

29. The pHRI of claim 28 further comprising a first thigh link assembly for transferring force from the actuation unit to a thigh of the user, the first thigh link assembly connecting to the first posterior strut at the first hip axis and including a first thigh strap arranged to for attaching the thigh link assembly to the user.

30. The pHRI of claim 29, wherein the first thigh link assembly defines a support panel to interface with a lumbar belt system and secure the lumbar belt system to the pHRI, the lumbar belt system configured to align the lumbar exoskeleton on iliac crests of the user.

31. A physical Human-Robot Interface (pHRI) arranged for attaching a lumbar exoskeleton to a user, the pHRI comprising:
a corset arranged for attaching the pHRI to a trunk of the user;
first and second posterior struts connected to the corset and arranged to bypass loads imposed on erector spinae of lower and middle back of the user and transfer assistive force from first and second actuation units of the lumbar exoskeleton to the user;
a lumbar belt system configured to align the lumbar exoskeleton on iliac crests of the user; and
wherein the first strut is connected to the corset by an adjustable linkage, the adjustable linkage including a first connector fixed to the corset and further including a second connector fixed to the first posterior strut.

32. The pHRI of claim 31 further comprising a first kinematic hip rotational joint connecting the first posterior strut to the first actuation unit and arranged to support hip flexion and extension about a first hip axis.

33. The pHRI of claim 32 further comprising a first thigh link assembly configured to transfer force from the actuation unit to a thigh of the user, the first thigh link assembly connecting to the first posterior strut at the first hip axis and including a first thigh strap arranged to for attaching the thigh link assembly to the user.

34. The pHRI of claim 33, wherein the first thigh link assembly defines a support panel arranged to secure the lumbar belt system to the pHRI.

35. The pHRI of claim 31, wherein the lumbar belt system comprises a dual waist belt assembly configured to permit circumferential regulation about the waist of the user, the dual waist belt assembly having a first semi-belt and a second semi-belt.

36. The pHRI of claim 33, wherein the thigh link assembly comprises a lateral hinge joint arranged to support lateral bending at a second hip axis.

37. The pHRI of claim 36, wherein the first thigh link assembly includes a rigid thigh support extending from the lateral hinge joint to a self-adaptive coupling having first and second components arranged to compensate for joint misalignment, the first component having a spherical pin surface against which the second component is configured to translate, the second component defining a slot for permitting movement, with respect to the first component in a single direction.

38. The pHRI of claim 36, the first thigh link assembly includes a rigid thigh support extending from the lateral hinge joint to a spherical joint, the spherical joint arranged to connect a thigh cuff to the thigh support.

39. The pHRI of claim 38, wherein the thigh cuff comprises a thigh strap that is engageable by the thigh of the user to produce resistive moments about the first hip axis.

40. A physical Human-Robot Interface (pHRI) arranged for attaching a lumbar exoskeleton to a user, the pHRI comprising:
a corset arranged for attaching the pHRI to a trunk of the user;
first and second posterior struts connected to the corset and arranged to bypass loads imposed on erector spinae of lower and middle back of the user and transfer assistive force from first and second actuation units of the lumbar exoskeleton to the user;
a first kinematic hip rotational joint connecting the first posterior strut to the first actuation unit and arranged for supporting hip flexion and extension about a first hip axis;
a lumbar belt system configured to align the lumbar exoskeleton on iliac crests of the user;
wherein the first strut is connected to the corset by an adjustable linkage;
wherein the adjustable linkage includes a first connector fixed to the corset and further includes a second connector adjustably attached to the first posterior strut;
wherein the second connector comprises an adjustable control to engage with a plurality of apertures along the first posterior strut; and
wherein movement between the first strut and the corset is constrained by the adjustable linkage to horizontal and vertical translations and rotations of the trunk of the user in sagittal, transverse, and coronal planes.
